(19) United States
(12) Patent Application Publication
(10) Pub. No.: US 2017/0035060 A1
(43) Pub. Date: Feb. 9, 2017

(54) Repellents, Repellent Systems, Methods of Forming Repellents, and Methods of Repelling Pests

(71) Applicant: Harold A. Cox, Spokane, WA (US)

(72) Inventor: Harold A. Cox, Spokane, WA (US)

(21) Appl. No.: 14/968,813

(22) Filed: Dec. 14, 2015

Related U.S. Application Data
(63) Continuation-in-part of application No. 14/820,061, filed on Aug. 6, 2015.

(51) Int. Cl. A01N 65/38; A01N 25/08; A01N 25/24; A01N 65/08

(52) U.S. Cl. CPC A01N 65/38; A01N 65/08; A01N 25/08; A01N 25/24

(57) ABSTRACT

Repellents that contain wax, oil and a repelling agent containing pepper are disclosed. Systems of repellents applied to a substrate to repel pests are disclosed. Methods of forming wax and pepper-containing repellents and methods of repelling pests that include applying wax-containing repellents to substrates are disclosed.

### RELATED PATENT DATA

This patent resulted from a continuation-in-part of U.S. patent application Ser. No. 14/820,061 which was filed Aug. 6, 2015 and which is hereby incorporated by reference.

### TECHNICAL FIELD

The invention pertains to repellents, repellent systems, methods of forming repellents and methods of repelling pests.

### BACKGROUND OF THE INVENTION

Many types of animals can cause damage to plants including crops, trees, bushes, shrubs, flowering plants, decorative foliage, etc. For example, ungulates and other herbivores can eat fruits, berries, nuts, blossoms, leaves, limbs, bark, shoots and other parts of trees and plants. These forms of plants, and other forms of plant life, including, for example, vegetables, grain crops, etc. can be similarly damaged by herbivores or other animals (e.g. raccoons, pigs, skunks, rodents, canines, birds, etc.).

Animals can also be a nuisance with respect to objects or containers such as trash receptacles, food (human or animal) storage receptacles or feeders. Additionally, predatory animals can be harmful to livestock, domestic animals, pets and other animals.

Conventional repellent technologies typically utilize repellent sprays or stakes that have limited uses or limited effectiveness, that require frequent reapplication, and/or that can only be applied at particular times or locations (non-edible portions of plants, non-producing seasons, areas remote or non-proximate relative to food portions, etc.). Application of conventional spray type repellents typically is performed while wearing a mask and/or protective clothing to avoid possible side effects of contact or inhalation.

It can be desirable to provide alternative repellents and methods of repelling pests.

### SUMMARY OF THE INVENTION

The invention encompasses repellents that contain wax, oil and a repelling agent containing pepper. Systems of the invention encompass repellents of the invention applied to a substrate to repel pests. Methods of the invention encompass forming wax and pepper-containing repellents and methods of repelling pests that include applying the repellents of the invention to substrates.

### BRIEF DESCRIPTION OF THE DRAWINGS

Preferred embodiments of the invention are described below with reference to the following accompanying drawings.

FIG. 1 depicts a repellent and a repellent system in accordance with one embodiment of the invention.

FIG. 2 illustrates a repellent system in accordance with another embodiment of the invention.

FIG. 3 illustrates a repellent system in accordance with another embodiment of the invention.

FIG. 4 is a flow chart diagram of repellent formation methods in accordance with one aspect of the invention.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

The invention involves repellent technologies that can be utilized in numerous applications and settings. The repellents of the invention can often be more widely applicable than conventional repellents and can be desirable due to less frequent re-application.

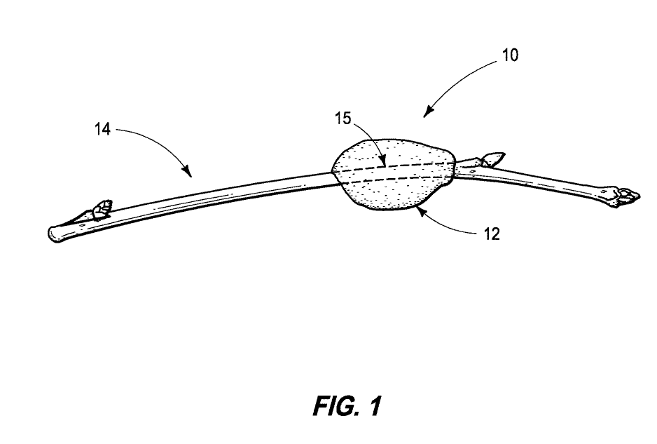

Repellents and repellent systems of the invention are described generally with reference to FIGS. 1-3. Referring initially to FIG. 1, a repellent system 10 in accordance with one embodiment is illustrated. Repellent system 10 includes a repellent 12 disposed on a surface 15 of a substrate 14.

Repellent 12 can comprise a wax substance and a repelling agent. The wax substance can comprise a single wax or can comprise a wax mixture comprising two or more waxes. Preferably, the wax substance comprises beeswax, alone or in combination with one or more additional waxes. It can be preferable to include beeswax in the wax substance to provide an appropriate melting temperature (around 146° F.). Additional or alternative waxes that can be utilized include, for example, blended paraffin wax, soy wax, soy wax mixtures, microcrystalline wax, polyethylene wax, petrolatum, berry wax, palm wax, slack wax and scale wax. The wax(es) utilized in the wax substance can be selected to provide a suitable malleability. In some aspects, it can be preferable to provide beeswax in the wax substance, either alone or in combination with one or more additional waxes, to provide increased malleability to the repellent relative to other waxes or mixtures of waxes.

It can be preferable that the wax substance has a relatively high melting temperature to reduce or avoid melting of the repellent on warm or hot days. Accordingly, the wax substance can preferably have a melting temperature equal to or greater than about 100° F. In particular applications, the melting temperature can be, for example greater than about 110° F., greater than about 120° F., or greater than about 150° F. The melting temperature of the wax substance can optionally be customized for the climate of the geographical regions where the repellent will be utilized.

The use of wax in repellent 12 can allow the repellent to be applied to and to adhere to a substrate, such as substrate 14 illustrated in FIG. 1. Wax can also act as a preservative to inhibit breakdown of the repelling agent (discussed below).

In particular embodiments of the invention, one or more additional ingredients selected from turpentine, rosin and pine tar can be added to the wax component or can replace a portion of the wax. It particular aspects of the invention, both turpentine and rosin can be included in the repellent and can replace a portion of beeswax (or other wax) utilized in the repellent. An example range of wax, turpentine and rosin that can be used is 7 parts beeswax (+/−3 parts), 12 parts rosin (+/−3 parts) and 5.5 parts turpentine (+/−3 parts), by weight. The presence and amount of turpentine and rosin used can depend upon the specific wax utilized (including any particular form of beeswax used). The presence of turpentine and rosin can beneficially be used to increase melting temperature and improve consistency of the repellent for better adherence.

Pine tar can be substituted for the rosin/turpentine to provide similar effects on melting temperature and consistency of the repellent. Alternatively, pine tar can be utilized in combination with turpentine and/or rosin (utilizing decreased portions of turpentine and rosin relative to the amounts set forth above). In embodiments where pine tar is included in the repellent, carbolic acid may additionally be included (optional).

The repelling agent utilized for repellents in accordance with the invention can be characterized as “pest” repelling agents. The term “pest” as used herein, can refer to one or more animals. Accordingly, the repellents of the invention can repel one or more animals. The repelling agent comprised by the repellents of the invention can preferably comprise one or more forms of pepper. In particular applications, the repelling agent can consist essentially of, or can consist of one or more forms of pepper. It is to be understood, however, that the invention contemplates utilization of other repellent agents, individually, in combination or combined with the one or more forms of pepper.

The form(s) of pepper utilized as the repelling agent can be crushed pepper, ground pepper, powdered pepper, pepper extract, or combinations thereof. Further, the form of pepper can be a form of red pepper, a form of black pepper, a form of green pepper, a form of white pepper, or any combination thereof. In particular applications, it can be preferable that the repelling agent comprise, consist essentially of, or consist of powdered red pepper due to potentially enhanced repelling properties (hotness, taste, smell) relative to other pepper forms.

The repellents of the invention can optionally additionally comprise one or more oils. Oils can be useful for improving workability (pliability and adhesion) of the repellent and to provide a useful consistency. Oil is utilized in aspects of the invention where a softer product is desirable and inclusion can depend upon the wax substance utilized. Further, inclusion of one or more oils can enhance washability of the repellent. Example oils that can be utilized include but are not limited to one or more of vegetable oils (including but not limited to soybean oil and/or cottonseed oil), hydrogenated vegetable oils, palm oil and/or petroleum oil. It can be preferable to utilize hydrogenated vegetable oil in some aspects of the invention due to the ease of combination of hydrogenated vegetable oil with various waxes and in particular with beeswax. Alternatively or additionally, one or more grease can be included in the repellent (e.g. petroleum grease).

Repellent 12 can also optionally comprise one or more preservative. Preservatives can be utilized to enhance the preservative properties of the wax substance to increase the useful lifetime of the repellent once applied and to decrease frequency of reapplication. Example preservatives that can be utilized include but are not limited to sodium nitrate, sodium nitrite, and other EPA approved preservatives.

As illustrated in FIG. 1, substrate 14 can be a portion of a plant such as a limb. Where the repellent is utilized for repelling pests from eating plants, the repellent can, in some instances, be applied directly to surface 15 of the plants. In the illustration shown in FIG. 1, repellent 12 is affixed to a limb of a tree, bush, shrub, etc. to repel pests from eating the limb. Typically, the repellent can be applied to lower level branches. However, to repel larger animals such as moose, it may be preferable to additionally apply the repellent to include branches, limbs etc. that are at a greater height on trees or larger shrubs/bushes. It is to be understood, however, that the repellent need not be applied to every limb to repel pests.

It can be possible to repel pests by applying repellent 12 to one or more limbs at various positions of the plants to dissuade pests from the entire plant. Further, it can be possible to repel pests from a group of plants by application of repellent 12 to only some of the plants in the group, such as application to plants on a perimeter of the group. Additionally, particular plants or plant types can be protected by application of repellent 12 to other nearby plants of the same or differing type. Alternatively, repellent 12 can be applied to objects near a plant or a group of plants to inhibit pests from eating or otherwise harming the plants.

Where new growth, limbs or other distal portions or plants are at risk, repellent 12 can be applied directly to those portions of the plants or to a region of the plants near the vulnerable areas. For example, in particular applications repellent 12 can be applied to a limb (substrate 14) from about 2 inches to about 3 inches from the tip to allow a stable support for the repellent and protect the limb, especially at a distal portion that can be most vulnerable.

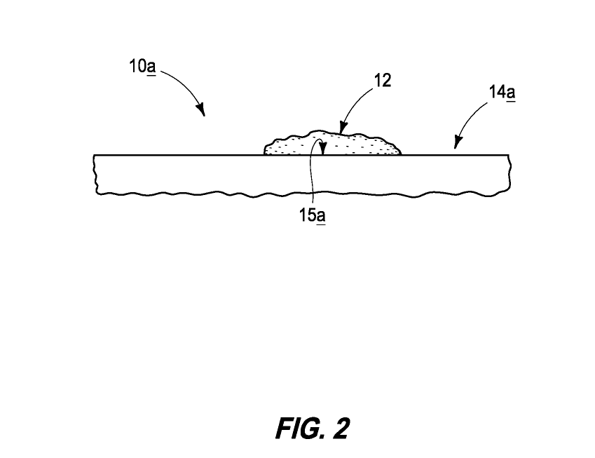

Referring next to FIG. 2, a repellent system 10a in accordance with another embodiment of the invention is illustrated. For ease of description, features identical to features described earlier are provided the identical numeric identifiers. Modified features are indicated with letter appendage “a” and new features are assigned a unique numeric identifier. Repellent system 10a includes the repellent 12 disposed on surface 15a of substrate 14a. As illustrated in FIG. 2, substrate 14 can be other than a limb. For example, substrate 14 can be another portion of a plant (bark, trunk, branch, root, or any other exposed portion) with surface 15a being a surface of such exposed surface.

Alternatively, substrate 14a can be a portion of a non-plant object to be protected and surface 15a can be a surface of such object. Examples of objects that can be protected can include but are not limited to trash receptacles, animal feeders, human or animal food storage containers, or any other object where protection is desired. Further, repellent 12 can be applied to items that can be placed on or near an object to be protected. Examples of substrate 14a for this type of “indirect” protection can include, for example, collars, pouches or tags to be placed upon animals to be protected; fences, posts, wires, stakes, flags, netting or other items in the proximity of objects to be protected.

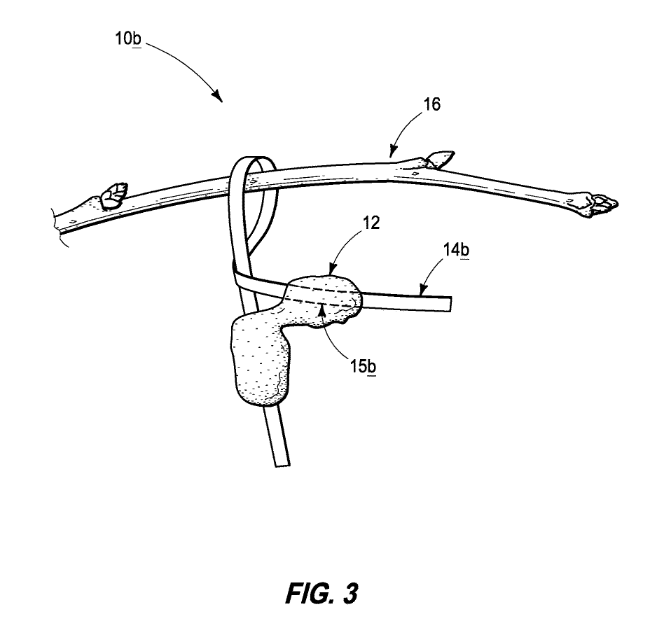

With reference to FIG. 3, a repellent system 10b in accordance with an alternative aspect of the invention is illustrated. Repellent system 10b includes repellent 12 disposed on a surface 15b of a substrate 14b that is a secondary material. The secondary material may be attached to an object 16 to be protected from pests. Object 16 can be, for example, any of the substrates described above and can, in some instances, be a portion of a plant as illustrated in FIG. 3. It may be preferable to dispose the repellent 12 to secondary material substrate 14b and attach the secondary material substrate 14b to an object in order to avoid direct contact between the repellent 12 and the object in the case of sensitive objects to be protected. It may also be possible, by applying repellent 12 to the secondary material substrate 14b, to expand the repelling effect of the repellent 12.

As shown in FIG. 3, repellent 12 can be applied to a secondary material, which is in turn attached to a limb or other portion of a plant. In instances where the plant will produce a crop or any other food for human or animal consumption (fruit, nuts, berries, vegetables, etc.), it may be desirable to inhibit or eliminate any potentially negative effect of the repellent being in direct contact with the plant. Utilization of an intervening secondary material can thereby inhibit or avoid absorption of any component of the repellent by the plant that could potentially affect the plant itself or the edible portion of the plant intended for harvest. Although none of the components of the repellent are toxic, by utilization of a secondary (intervening) material, any potential for taste, smell etc. of the repellent to be introduced to edible portions of the plant can be minimized or eliminated. Similarly, use of a secondary material with non-plant substrates can minimize or eliminate the possibility of staining, discoloration, retention of odors, etc. It has been found that the repellent, in at least some instances, does not confer any taste to fruit produced from plants upon which the repellent has been directly applied. However, it can be desirable to further decrease any possibility of taste transfer by utilization of a secondary material.

Example secondary materials that can be utilized for plant and/or non-plant items to be protected include but are not limited to a twist tie, a cloth, plastic, tape, wire, a hook, a rope or twine, a nail, a tack, an animal collar, a tag, a pouch material or any other material that can be adhered to, wrapped around or otherwise affixed to an object to be protected.

Although the substrates discussed above have been described as being an item or object to be protected or a secondary material to be attached to an item/object to be protected, it is to be understood that a substrate in accordance with the invention can also include an object proximate an item to be protected or a secondary material to be attached to an item to be protected. For example, repellent can be applied to a fence, post, or any other object near plants, animals, or other items to be protected. Similarly, repellent can be applied to a secondary material either prior to or after affixing the secondary material to an object proximate one or more items to be protected.

Although repellents of the invention in general do not harm any substrate or surface to which they are applied, if discoloration or staining is a concern, the specific form of repelling agent can be selected to minimize any potential visual marring. For example, the pepper utilized in the repelling agent can be selected based upon color. For example, if a plant is to be protected by application of repellent to the plant, the pepper utilized can consist of green pepper. Similarly, if the repellent is to be applied to a black surface or animal, the form of pepper to be utilized can consist of black pepper. Other pepper colors or color combinations can be utilized based upon similar reasoning.

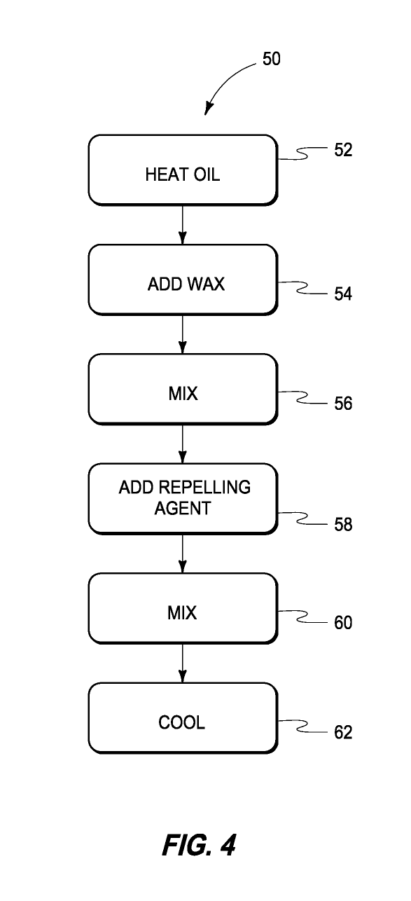

The flow chart set forth in FIG. 4 shows an example method 50 that can be utilized for making repellents in accordance with the invention. Method 50 can utilize an initial process comprising heating of one or more oils. The one or more oils can be any of the oils described above. The heating can preferably be conducted at a sufficient temperature to allow for blending of additional components of the invention. The oil(s) can be heated in any appropriate vessel utilizing any appropriate method of heat application.

One or more waxes (or wax mixture including one or more of rosin, turpentine and pine tar as described above), can be added to the oil and melted to blend the oil and wax in a subsequent process 54 as illustrated. Alternatively, the wax can be added to the oil prior to or during the heating process. The melted wax(es) and oil can be mixed in a mixing process 56. The amount of oil utilized relative to the wax is not limited to any particular value and can depend upon the specific wax(es) and oil(s) being utilized. An appropriate amount of oil will provide a mixable combination of wax and oil and produce a pliable but not excessively sticky product. Too much oil can significantly decrease the melting temperature of the repellent while too little oil can cause the repellent to be too thick or hard to work with. An example amount of oil can be about 2-8 parts oil to about 11-17 parts wax (or wax mixture) substance, by weight.

In a subsequent process stage 58 the repelling agent can be added to the melted wax substance and the components can be combined utilizing a mixing process 60 to form the repellent. In a preferred embodiment, equal parts (by weight) of repelling agent and wax substance can be utilized, although the amount of oil can be increased or decreased relative to the wax by about 2-3 parts. In one preferred embodiment, the repellent of the invention can comprise 14 parts wax, 14 parts repelling agent and 5 parts oil, by weight.

In embodiments where one or more optional preservative is utilized, the preservative can be added during the melting process 52, during the addition of oil 54 during mixing stage 56 or during or after the adding of the repellent stage 58. Where the preservative is provided in liquid form, it can be preferable to add the preservative prior to addition of the repelling agent. Where the preservative is provided in dry form, it can be preferable to add the preservative after adding the oil.

A final stage 62 in the method is to cool the repellent. Cooling process can comprise letting the repellent cool or can comprise refrigeration. Cooling can be conducted to complete cooling (e.g. to room temperature or partially cooling that is sufficient to allow application of the repellent to a substrate. The degree of cooling can depend upon the substrate to which the repellent is to be applied.

Methods of repelling pests in accordance with the invention include applying any of the repellents described above to a substrate. The substrate can be an object to be protected such as any of those items discussed above, can be an object proximate or in the vicinity to one or more items to be protected, or can be a secondary material attached to, or to be attached to any of these objects.

Application of the repellents of the invention typically includes providing an amount of the repellent, contacting a substrate surface with the repellent and pressing or otherwise applying pressure to the repellent to affix the repellent to the surface. The amount of repellent applied to any one point of application can depend upon the surface and/or substrate to which the repellent is being applied. For example, where the repellent is being applied to a limb, an amount of repellent utilized per limb can be from about 0.5 grams to about 2 grams depending upon the size of the limb.

Where the repellent is being utilized to protect a plant, the repellent can be applied to one or more surface locations of the plant. For instance, the repellent can be applied to spaced apart limbs or branches at various locations around the circumference and at various elevations of the tree, shrub, bush etc. Where pests such as animals that contact, rub, eat or otherwise damage larger portions of plants are to be repelled, the repellent can alternatively or additionally be applied to stem or trunk areas. The elevation of application can depend upon the pests to be repelled. In some instances, application of repellent can comprise forming a ring of repellent around the stem or trunk. The ring can be a continuous line of repellent or can be intermittent.

Where the repellent is applied to non-plant surfaces, the amount applied in a particular location can be as little as 0.5 grams or can be up to about 5 grams or more depending upon the size of the substrate. If a secondary substrate is to be utilized, the amount can vary depending upon the size of the secondary substrate and/or the size of the object to be protected. Additionally, for all applications, the amount of repellent utilized, the positioning of the repellent and whether or not any secondary substrate is utilized can depend upon the type of pest(s) to be repelled as well as the type and size of the object or subject to be protected.

Application of the repellents of the invention can be performed manually utilizing hands or a tool that can be used for collecting an appropriate repellent amount from a container and pressing the amount to a surface or a substrate. Where the repellent is applied to limbs, it can be preferable to apply the repellent by hand by pressing an amount of repellent to individual limbs. The repellent can be provided to entirely surround a length of a limb or can be applied along one or more sides of the limb.

Where the repellent is to be applied to a large surface, the repellent can be applied at multiple spaced locations on the surface or can be applied to cover larger areas or an entirety of a surface. If a relatively large area is to be covered, it may be preferable to provide a thin layer of repellent on the surface. In some instances, it may be beneficial to only partially cool the repellent after making, or warming the repellent to allow spreading of the repellent to form a layer over a substrate.

Tools that can be utilized that can assist in certain application processes can include but are not limited to putty knives or similar tools that can be used to remove the repellent from a container and/or press or spread the repellent onto a substrate. Gloves and/or other protective clothing can be worn to inhibit or avoid direct contact of the repellent with skin. Although the repellents of the invention are non-toxic, it can be desirable to minimize possible sticking of the repellent to skin and/or irritation by or absorption of any repelling agent.

Where a secondary material is utilized (discussed above), application of repellent can utilize any of the methods discussed above for application to the secondary material. The repellent can be applied to the secondary material either prior to or subsequent to affixing the secondary material to an object. Further, it can be possible to apply the repellent to a secondary material prior to cooling of the repellent, after less than complete cooling of the repellent or after rewarming of the coolant. Accordingly, the warm repellent can be coated onto a portion of the secondary material or the secondary material may be dipped into the warm repellent and subsequently be affixed to the appropriate object.

The repellents of the invention can typically have a longer effective lifetime relative to conventional repellents. Repellents of the invention can have an effective lifetime of from about 6 months to about a year. Weather conditions and type of substrate can affect the effective lifetime. Accordingly, re-application can be performed as needed upon expiration of the predicted effective life. For example, reapplication can be performed from about 6 months to about 12 months after initial application. Reapplication can alternatively be performed more frequently based upon pest behavior. For example, reapplication can be performed if pests begin to invade prior to predicted lifetime of the repellent, or if the repellent begins to have diminished effectiveness toward one or more pests.

The repellents of the invention can be relatively inexpensive as compared to many conventional repellents. The repellents of the invention are non-toxic and are easily cleaned from surfaces and from skin and tools utilized for application. Further, the effective life of the repellents can exceed those of conventional repellents and application/reapplication is relatively easy. Additionally, the repellents of the invention can avoid or minimize contamination of nearby areas on an object to be protected and/or surrounding areas. In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

The invention claimed is:

1. A repellent composition comprising:
a wax substance containing at least one wax and optionally comprising one or more members of the group consisting of turpentine, rosin and pine tar; and
a repelling agent comprising at least one form of pepper.

2. The repellent composition of claim 1 further comprising at least one oil.

3. The repellent composition of claim 1 wherein the wax substance comprises rosin and turpentine.

4. The repellent composition of claim 1 wherein the wax substance comprises pine tar.

5. The repellent composition of claim 1 wherein the at least one form of pepper comprises one or more of white pepper, black pepper, red pepper, and green pepper.

6. The repellent composition of claim 1 wherein the wax substance has a melting temperature greater than or equal to 140° F.

7. The repellent composition of claim 1 wherein the wax substance comprises a mixture of one or more wax selected from the group consisting of beeswax, blended paraffin wax, soy wax, soy wax mixtures, microcrystalline wax, polyethylene wax, petrolatum, berry wax, palm wax, slack wax and scale wax.

8. A process of making a repellent composition, comprising:
heating an oil;
adding a wax mixture comprising one or more waxes and one or more of turpentine, rosin and pine tar to the oil to form a wax-oil mixture; and
adding a repelling agent to the wax-oil mixture.

9. The process of claim 8 wherein the repelling agent comprises one or more forms of pepper.

10. The process of claim 8 wherein the one or more forms of pepper comprise one or more of crushed pepper, ground pepper, powdered pepper, and pepper extract.

11. The process of claim 8 wherein the one or more forms of pepper comprises one or more of white pepper, black pepper, red pepper, and green pepper.

12. The process of claim 8 wherein the wax mixture melts during the process and wherein the heating is performed prior to adding the repelling agent.

13. A method of repelling pests, comprising:
providing a wax-based animal repellent, the animal repellent comprising at least one wax and one or more members of the group consisting of rosin, turpentine and pine tar; and
applying the wax-based animal repellent to a substrate.

14. The method of claim 13 wherein the applying comprises pressing the wax based animal repellent to the substrate.

15. The method of claim 13 wherein the wax based animal repellent comprises one or more forms of pepper.

16. The wax based animal repellent of claim 15 wherein the one or more forms of pepper comprises one or more of crushed pepper, ground pepper, powdered pepper, and pepper extract.
